(19) United States
(12) Patent Application Publication
(10) Pub. No.: US 2014/0349842 A1
(43) Pub. Date: Nov. 27, 2014

(54) PREPARATION METHOD OF POLYESTER SYNTHESIS COMPOSITE CATALYST

(71) Applicants: KUNSHAN TIANYANG HOT MELT ADHESIVE CO., LTD., Kunshan, Jiangsu (CN); EAST CHINA UNIVERSITY OF SCIENCE AND TECHNOLOGY, Shanghai (CN); SHANGHAI TIANYANG HOT MELT ADHESIVE CO., LTD., Shanghai (CN)

(72) Inventors: Zuoxiang Zeng, Shanghai (CN); Lujie Wang, Shanghai (CN); Zhelong Li, Shanghai (CN); Wanyu Zhu, Shanghai (CN); Tao Han, Shanghai (CN); Yan Shen, Shanghai (CN)

(21) Appl. No.: 14/360,893

(22) PCT Filed: May 31, 2013
(86) PCT No.: PCT/CN2013/076580

§ 371 Date: May 27, 2014

(30) Foreign Application Priority Data
Jun. 7, 2012 (CN) 201210186360.6

(51) Int. Cl. C08G 63/85

(52) U.S. Cl. CPC C08G 63/85
USPC 502/169

(57) ABSTRACT

A method of preparing a composite catalyst for polyester synthesis includes the steps of: 1) sequentially dissolving a titanium compound, a silicon compound and a tin compound in an organic solvent; 2) adding a water solution of an acidic compound or of an alkaline compound in the compound from step 1) to cause hydrolysis thereof and collecting a precipitate, and washing the hydrolysis precipitate with a deionized water to obtain the composite catalyst. The catalyst is not only effective in polyester production polycondensation, but also has significant catalytic activity in esterification. The produced polyester chips all have a desirable hue.

### TECHNICAL FIELD

The present invention relates to catalysts for polyester synthesis, and more particularly to Ti/Si/Sn composite catalysts suited to the use in esterification and polycondensation reactions for the synthesis of polyesters and co-polyesters.

### BACKGROUND

Polyesters generally refer to polymeric products resulting from the polycondensation between diols and dicarboxylic acids, which are excellent and widely used engineering plastics having great importance in applications such as films, packaging bottles and sheets.

Since the advent of polyesters, endless research has been carried out to find suitable catalysts for their synthesis. Current studies and industrial applications in this regard are focused on antimony (Sb)-, germanium (Ge)- and titanium (Ti)-based catalysts, with the Sb-based ones (including antimony trioxide (Sb₂O₃), antimony triacetate (SbAc₃), antimony glycolate and so forth) most widely used in practice. Nowadays, nearly 90% of the polyester products in the world are produced by using Sb-based catalysts. Although Sb-based catalysts have appropriate reactivity and less side reactions, antimony will be reduced and precipitate during the use of Sb-based catalysts in polyester synthesis, thus dying the resulting polyester chips gray and leading to increase in spin pack pressure; moreover, Sb-based catalysts are heavy metal catalysts, they are environmental pollutants and hence detrimental to sustainable development. Additionally, while Ge-based catalysts generally have high stability and can result in polyester articles having a good hue, the high market price of germanium metal greatly limits their use. Further, although Ti-based catalysts are presently the focus of research in this area due to their high reactivity and absence of heavy metal components, inorganic salts and organic esters of titanium used in the early time have been found to result in yellowing or cloudy polyester products that are lack of stability and hence have limited application.

Chinese patent application No. 95191164.3 to Acordis Corp. discloses C-94, a non-toxic, efficient catalyst, which contains TiO₂/SiO₂ and TiO₂/ZrO₂ as the main components and is suitable to be used in the production of polyethylene terephthalate (PET), polybutylene terephthalate (PBT), polytrimethylene terephthalate (PTT), etc.; Zimmer Corp. develops two kinds of catalysts, namely Ecocat B and Ecocat T, which are catalytically active metal oxides able to be absorbed on a non-homogeneous carrier during polycondensation; Synetix Corp., the subsidiary of Imperial Chemical Industries PLC (ICI), provides a series of titanium based catalysts for polyesters synthesis including AC400, AC300, AC200 and AC240; CN1138339 discloses a Ti-based catalyst produced from the cohydrolysis of a titanate and a silicate; and CN1259969 discloses a Ti-based catalyst produced from the co-precipitation of a titanate with another metal compound.

None of these catalysts can, however, result in polyester with a desirable hue whose value is lower than that of polyester resulting from the Sb-based ones and none of these catalysts can address the issue of yellowing products. Therefore, there is currently no available Ti-based catalyst that has satisfactory catalytic activity both in esterification and polycondensation reactions and can result in products with a satisfying hue.

### SUMMARY OF THE INVENTION

An objective of the present invention is to provide a method of preparing a composite catalyst for polyester synthesis. The prepared solid catalyst is effective not only in polyester production polycondensation but also in esterification reactions, while being capable of resulting in polyester chips with a desirable hue.

In accordance with the above and further objectives of the invention, a method of preparing a composite catalyst for polyester synthesis includes the steps of:

1) performing a hydrolysis reaction by dissolving a titanium compound, a silicon compound and a tin compound in an organic solvent and adding therein a water solution of an acidic compound or a water solution of an alkaline compound at a temperature of 15° C.˜30° C. for 0.5 hour˜1 hour; and

2) collecting, after the hydrolysis reaction, a hydrolysis precipitate and washing the hydrolysis precipitate with a deionized water to obtain the composite catalyst,

wherein the titanium compound is of a formula of Ti(OR¹)₄, where R¹ is C₂₋₄-alkeyl;

wherein the silicon compound is of a formula of Si(OR²)₄, where R² is C₂₋₄-alkeyl;

wherein the tin compound is tin tetrachloride (SnCl₄);

wherein a molar ratio of the silicon compound to the titanium compound is 0.05:1˜0.5:1; and

wherein a molar ratio of the tin compound to the titanium compound is 0.1:1˜5:1.

The organic solvent may be selected from the group consisting of C₁₋₆-monohydric alcohols and C₁₋₆-polyhydric alcohols, and a molar ratio of the organic solvent to a total of the titanium compound, the silicon compound and the tin compound may be 10:1˜40:1.

Further, a molar ratio of the organic solvent to a total of the titanium compound, the silicon compound and the tin compound may preferably be 15:1˜20:1.

Further, the titanium compound may be selected from the group consisting of tetraethyl titanate, tetrapropyl titanate, tetraisopropyl titanate and tetrabutyl titanate.

Further, the silicon compound may be selected from the group consisting of tetraethyl orthosilicate and tetrabutyl orthosilicate.

Further, a molar ratio of the silicon compound to the titanium compound may be 0.06:1˜0.1:1, and a molar ratio of the tin compound to the titanium compound may be 0.5:1˜1:1.

Further, the organic solvent may be selected from the group consisting of methanol, ethanol, isopropanol, isobutanol, hexanol, glycol, butanediol, hexanediol and glycerol.

Further, the organic solvent may be ethanol.

In the step of hydrolysis, the acidic or alkaline compound is added in a predetermined amount, i.e., with a predetermined pH of the water solution thereof, to control the hydrolysis rate of the metal salts. The acidic compound may include various inorganic or organic acids, with phosphoric acid, hydrochloric acid and sulfuric acid as the preferred inorganic acid, and with acetic acid as the preferred organic acid, while the alkaline compound may be selected from the group consisting of ammonium hydroxide, sodium hydroxide and potassium hydroxide.

The water solution of the acidic compound may have a pH of 1˜4 and the water solution of the alkaline compound may have a pH of 11˜14.

The polyester synthesis in accordance with the method of the invention is achieved by a two-step reaction, i.e, an esterification reaction and a polycondensation reaction. Specifically, in the first step, an esterification reaction is performed between one or more dicarboxylic acids and one or more diols to produce a pre-polymer, wherein the esterification reaction is performed under the atmospheric pressure at a temperature of 200° C.˜240° C.; and in the second step, a polycondensation reaction is performed under a vacuum condition with a pressure of 60 Pa˜130 Pa at a temperature of 240° C.˜260° C. The composite catalyst is used in an amount of 200 ppm˜250 ppm calculated based on the total weight of the diols and dicarboxylic acids.

Compared to the prior art, the novelty of the present invention lies in adding the tin compound to the mixture of the titanium and silicon compounds prior to the cohydrolysis. The composite catalyst obtained in this way is effective both in polyester production polycondensation and in esterification and can result in a polyester product with a desirable hue.

### DETAILED DESCRIPTION OF THE INVENTION

The invention is explained in greater detail below on the basis of the following embodiments which are illustrative and not limitative of the invention. Melt flow rate (MFR) of each polyester product prepared in the embodiments was measured in accordance with the P.R.C. national standard GB/T3682-2000. The value b provided in Table 1, which indicates the degree of blueness to yellowness, is a crucial measure of the corresponding product's hue and is measured in accordance with the national standard GB/T14190-93, the smaller the value b, the better the hue of the product.

All materials and reagents used in the embodiments were all commercially available.

### Embodiment 1

17 g (0.05 mol) of tetrabutyl titanate, 1.2 g (0.0058 mol) of tetraethyl orthosilicate and 6.5 g (0.025 mol) of tin tetrachloride were dissolved in 86 ml of anhydrous ethanol to produce a solution A. 9.0 g of phosphoric acid solution with a pH of 1 was added in another 86 ml of anhydrous ethanol to produce a solution B. Next, the solution B was titrated in the solution A in 0.5 hour with sufficient stirring at a temperature of 15° C. to produce white precipitate, and after the titration was completed, the whole system was further stirred for one hour and thereafter centrifuged to separate the precipitate. Afterward, the precipitate was collected, washed 3 times with water, and dried for 24 hours at a temperature of 70° C., to prepare a composite catalyst Cat-1.

### Embodiment 2

27.2 g (0.08 mol) of tetrabutyl titanate, 1.5 g (0.0072 mol) of tetraethyl orthosilicate and 15.6 g (0.06 mol) of tin tetrachloride were dissolved in 134 ml of anhydrous ethanol to produce a solution A. 20.9 g of hydrochloric acid solution with a pH of 4 was added in another 134 ml of anhydrous ethanol to produce a solution B. Next, the solution B was titrated in the solution A in 0.5 hour with sufficient stirring at a temperature of 20° C. to produce white precipitate, and after the titration was completed, the whole system was further stirred for 45 minutes and thereafter centrifuged to separate the precipitate. Afterward, the precipitate was collected, washed 3 times with water, and dried for 24 hours at a temperature of 70° C., to prepare a composite catalyst Cat-2.

### Embodiment 3

22.7 g (0.08 mol) of tetraisopropyl titanate, 2.2 g (0.0106 mol) of tetraethyl orthosilicate and 20.8 g (0.08 mol) of tin tetrachloride were dissolved in 139 ml of anhydrous ethanol to produce a solution A. 18.1 g of deionized water which had an appropriate amount of ammonium hydroxide added therein and had a pH of 11 was dissolved in another 139 ml of anhydrous ethanol to produce a solution B. Next, the solution B was titrated in the solution A in 0.5 hour with sufficient stirring at a temperature of 30° C. to produce white precipitate, and after the titration was completed, the whole system was further stirred for 1 hour and thereafter centrifuged to separate the precipitate. Afterward, the precipitate was collected, washed 3 times with water, and dried for 24 hours at a temperature of 70° C., to prepare a composite catalyst Cat-3.

### Embodiment 4

14.2 g (0.05 mol) of tetraisopropyl titanate, 0.8 g (0.0038 mol) of tetraethyl orthosilicate and 13 g (0.05 mol) of tin tetrachloride were dissolved in 230 ml of anhydrous ethanol to produce a solution A. 36 g of sodium hydroxide solution with a pH of 14 was added in another 230 ml of anhydrous ethanol to produce a solution B. Next, the solution B was titrated in the solution A in 0.5 hour with sufficient stirring at a temperature of 25° C. to produce white precipitate, and after the titration was completed, the whole system was further stirred for 1 hour and thereafter centrifuged to separate the precipitate. Afterward, the precipitate was collected, washed 3 times with water, and dried for 24 hours at a temperature of 70° C., to prepare a composite catalyst Cat-4.

### Embodiment 5

1.5 mol of terephthalic acid and 2.4 mol of butanediol were added in a 2 L reactor. Afterward, 0.11 g (i.e, 220 ppm) of the catalyst Cat-1 was further added in the reactor to initiate the esterification reaction. The reaction was run under the atmospheric pressure at a temperature of 220° C. to 240° C., with a rectifying apparatus employed to remove water resulting from the reaction. Upon the completion of the esterification reaction, the pressure of the reactor was reduced to lower than 130 Pa, with the temperature thereof increased to 255° C. concurrently. The system was further subjected to such conditions until a desired viscosity was reached, so as to prepare polyester P1 for testing. The test results were presented in Table 1.

### Embodiment 6

1.5 mol of terephthalic acid and 2.4 mol of butanediol were added in a 2 L reactor. Afterward, 0.12 g (i.e, 250 ppm) of the catalyst Cat-2 was further added in the reactor to initiate the esterification reaction. The reaction was run under the atmospheric pressure at a temperature of 220° C. to 240° C., with a rectifying apparatus employed to remove water resulting from the reaction. Upon the completion of the esterification reaction, the pressure of the reactor was reduced to lower than 130 Pa, with the temperature thereof increased to 255° C. concurrently. The system was further subjected to such conditions until a desired viscosity was reached, so as to prepare polyester P2 for testing. The test results were presented in Table 1.

### Embodiment 7

1.5 mol of terephthalic acid and 2.4 mol of butanediol were added in a 2 L reactor. Afterward, 0.12 g (i.e., 250 ppm) of the catalyst Cat-3 was further added in the reactor to initiate the esterification reaction. The reaction was run under the atmospheric pressure at a temperature of 220° C. to 240° C., with a rectifying apparatus employed to remove water resulting from the reaction. Upon the completion of the esterification reaction, the pressure of the reactor was reduced to lower than 130 Pa, with the temperature thereof increased to 255° C. concurrently. The system was further subjected to such conditions until a desired viscosity was reached, so as to prepare polyester P3 for testing. The test results were presented in Table 1.

### Embodiment 8

1.5 mol of terephthalic acid and 2.4 mol of butanediol were added in a 2 L reactor. Afterward, 0.09 g (i.e., 200 ppm) of the catalyst Cat-4 was further added in the reactor to initiate the esterification reaction. The reaction was run under the atmospheric pressure at a temperature of 220° C. to 240° C., with a rectifying apparatus employed to remove water resulting from the reaction. Upon the completion of the esterification reaction, the pressure of the reactor was reduced to lower than 130 Pa, with the temperature thereof increased to 255° C. concurrently. The system was further subjected to such conditions until a desired viscosity was reached, so as to prepare polyester P4 for testing. The test results were presented in Table 1.

### Embodiment 9

1.2 mol of terephthalic acid, 0.225 mol of isophthalic acid, 0.075 mol of adipic acid, 2.565 mol of butanediol and 0.285 mol of hydroxyethylated bisphenol A were added in a 2 L reactor. Afterward, 0.11 g (i.e., 220 ppm) of the catalyst Cat-1 was further added in the reactor to initiate the esterification reaction. The reaction was run under the atmospheric pressure at a temperature of 220° C. to 240° C., with a rectifying apparatus employed to remove water resulting from the reaction. Upon the completion of the esterification reaction, the pressure of the reactor was reduced to lower than 130 Pa, with the temperature thereof increased to 255° C. concurrently. The system was further subjected to such conditions until a desired viscosity was reached, so as to prepare polyester P5 for testing. The test results were presented in Table 1.

### Comparative Embodiment 1

polyester B1 was prepared according to the same method as Embodiment 5 except using 0.12 g (i.e., 250 ppm) of tetrabutyl titanate as the catalyst. The prepared polyester B1 was tested and the results were presented in Table 1.

### Comparative Embodiment 2

polyester B2 was prepared according to the same method as Embodiment 9 except using 0.12 g of tetrabutyl titanate and 0.36 g of butylstanoic acid as catalysts, i.e., the total concentration of the catalysts was 1000 ppm. The prepared polyester B2 was tested and the results were presented in Table 1.

TABLE 1
Relationship between characteristics of polyesters and catalysts used

| | | Catalyst | Esterification | Polycondensation | | |
|---|---|---|---|---|---|---|
| | | concentration | time | time | MFR | |
| Polyester | Catalyst | (ppm) | (min.) | (min.) | (g/10 min) | value b |
| P1 | Cat-1 | 220 | 72 | 90 | 24.3 | 2.2 |
| P2 | Cat-2 | 250 | 84 | 85 | 27.4 | 2.4 |
| P3 | Cat-3 | 250 | 78 | 98 | 26.5 | 1.7 |
| P4 | Cat-4 | 200 | 85 | 100 | 25.7 | 2.6 |
| P5 | Cat-1 | 220 | 80 | 82 | 23.6 | 2.8 |
| B1 | Tetrabutyl | 250 | 220 | 270 | 28.7 | 3.9 |
| | titanate | | | | | |
| B2 | Tetrabutyl | 250/ | 131 | 117 | 29.6 | 6.4 |
| | titanate/ | 750 | | | | |
| | butylstanoic | | | | | |
| | acid | | | | | |

What is claimed is:

1. A method of preparing a composite catalyst for polyester synthesis, comprising the steps of:
1) performing a hydrolysis reaction by dissolving a titanium compound, a silicon compound and a tin compound in an organic solvent and adding therein a water solution of an acidic compound or a water solution of an alkaline compound at a temperature of 15° C.˜30° C. for 0.5 hour˜1 hour, wherein the water solution of the acidic compound has a pH of 1˜4 and the water solution of the alkaline compound has a pH of 11˜14; and
2) collecting, after the hydrolysis reaction, a hydrolysis precipitate and washing the hydrolysis precipitate with a deionized water to obtain the composite catalyst, wherein the titanium compound is of a formula of Ti(OR¹)₄, where is C₂₋₄-alkeyl;
wherein the silicon compound is of a formula of Si(OR²)₄, where R² is C₂₋₄-alkeyl;
wherein the tin compound is tin tetrachloride;
wherein a molar ratio of the silicon compound to the titanium compound is 0.05:1˜0.5:1; and
wherein a molar ratio of the tin compound to the titanium compound is 0.1:1˜5:1.

2. The method of claim 1, wherein the organic solvent is selected from the group consisting of C₁₋₆-monohydric alcohols and C₁₋₆-polyhydric alcohols, and a molar ratio of the organic solvent to a total of the titanium compound, the silicon compound and the tin compound is 10:1˜40:1.

3. The method of claim 2, wherein the organic solvent is selected from the group consisting of methanol, ethanol, isopropanol, isobutanol, hexanol, glycol, butanediol, hexanediol and glycerol.

4. The method of claim 3, wherein the organic solvent is ethanol.

5. The method of claim 2, wherein the molar ratio of the organic solvent to the total of the titanium compound, the silicon compound and the tin compound is 15:1˜20:1.

6. The method of claim 1, wherein the acidic compound is selected from the group consisting of phosphoric acid, hydrochloric acid, sulfuric acid and acetic acid, and the alkaline compound is selected from the group consisting of ammonium hydroxide, sodium hydroxide and potassium hydroxide.

7. The method of claim 1, wherein the titanium compound is selected from the group consisting of tetraethyl titanate, tetrapropyl titanate, tetraisopropyl titanate and tetrabutyl titanate.

8. The method of claim 1, wherein the silicon compound is selected from the group consisting of tetraethyl orthosilicate and tetrabutyl orthosilicate.

9. The method of claim 1, wherein a molar ratio of the silicon compound to the titanium compound is 0.06:1˜0.1:1, and a molar ratio of the tin compound to the titanium compound is 0.5:1˜1:1.
